(19) United States
(12) Patent Application Publication
(10) Pub. No.: US 2007/0270323 A1
(43) Pub. Date: Nov. 22, 2007

(54) METAL CLEANER CONTAINING POLYETHYLENE IMINE

(76) Inventors: Bernd Stedry, Kempen (DE); Andreas Heinze, Langenfeld (DE); Werner Opitz, Langenfeld (DE); Gerhard Rehm, Niefern-Oeschelbronn (DE)

Correspondence Address: HENKEL CORPORATION, THE TRIAD, SUITE 200, 2200 RENAISSANCE BLVD., GULPH MILLS, PA, 19406, US

(21) Appl. No.: 11/753,903

(22) Filed: May 25, 2007

Related U.S. Application Data
(63) Continuation of application No. PCT/EP05/09768, filed on Sep. 18, 2005.

(30) Foreign Application Priority Data
Nov. 29, 2004 (DE) 10 2004 057 623.8

(51) Int. Cl. B08B 7/00

(52) U.S. Cl. 510/201; 134/42

(57) ABSTRACT

A process for cleaning metal surfaces is provided using a neutral industrial cleaner, which comprises a combination of non-ionic surfactants and/or glycol ethers, and polyethylene imine. The cleaner has a demulsifying effect on fats and/or oils on metal surfaces and in the cleaning solution allowing separation and reuse of the cleaner. The cleaner is low-foaming and can advantageously be used in spray application.

### CROSS-REFERENCE TO RELATED APPLICATIONS

This application is a continuation under 35 USC Sections 365(c) and 120 of International Application No. PCT/EP2005/009768, filed 18 Sep. 2005 and published 8 Jun. 2006 as WO2006/058570, which claims priority from German Application No. 102004057623.8 filed 29 Nov. 2004, which is incorporated herein by reference in its entirety.

### FIELD OF THE INVENTION

This invention relates to a cleaning preparation (in the form of a concentrate and ready-to-use solution) for hard surfaces, more particularly metallic surfaces. Accordingly, the cleaning preparation according to the invention is a so-called industrial cleaner, more particularly a so-called neutral cleaner. By virtue of its particular combination of non-ionic surfactants or glycol ethers and polyethylene imine, it is low-foaming and may therefore be used with advantage as a spray cleaner throughout the applicationally relevant temperature range of about 15 to about 80° C. In addition, it is demulsifying and, hence, easy to reprocess.

### DISCUSSION OF THE RELATED ART

Industrial cleaners of the type in question are mainly used in the automotive industry and its suppler industries for cleaning and passivation, predominantly in spray cleaning installations. They are suitable for the intermediate and final cleaning of formed and machined parts in assembly and fitting shops. Almost all relevant materials, such as iron and steel, aluminum, silumin (aluminum alloy containing between 4% and 22% silicon), copper, brass, zinc and plastics, can be treated and the majority of organic or inorganic soils, such as cooling lubricants, rustproofing oils, machining oils, drawing aids, pigments and light metal abrasion dust, can be removed. Cleaners of the type in question can also be used in standard immersion processes, although normally they are preferably applied by spraying.

U.S. Pat. No. 5,904,735 describes detergent formulations (evidently for washing textiles) which contain surfactants, builders, enzymes and 0.001 to 5% by weight polyethylene imine. (Polyethylene imine is hereinafter referred to in short as PEI). The reason why PEI is used in this detergent formulation is that it improves the stain-removing effect of bleach-free detergents. Suitable surfactants may be selected from the entire range of anionic surfactants, non-ionic surfactants, zwitterionic surfactants, ampholytic surfactants, cationic surfactants and mixtures thereof.

WO 95/03389 describes a cleaner for industrial applications of which the particular advantage is that weakly polar plastic surfaces are thoroughly wetted. This is largely attributable to the use of certain amino acids. In addition, the cleaner in question contains non-ionic surfactants preferably selected from the group of ethoxylated and/or ethoxylated and propoxylated fatty alcohols.

For many industrial applications, it is desirable for the cleaning solution to have demulsifying properties. This means that, although oily soil types are easily removed from the surfaces to be degreased, they do not form a stable emulsion in the aqueous cleaning solution, but float as an oily phase on the water-based cleaner at the working temperature or optionally after temperature adaptation and/or dilution. The oil phase can then easily be removed from the cleaning solution, so that the useful life of the cleaning bath can be significantly extended. The cleaning solutions according to WO 95/03389 can also have this property providing they contain cationic surfactants, betaines and/or cationically modified polymers in quantities of 0.01 to 3% by weight. This document mentions a large number of cationic or zwitterionic compounds that may be used for this purpose, including protonated PEI or methylated PEI. These polymers are said to have comparatively high molecular weights in the range from 50,000 to 50,000,00 and preferably in the range from 75,000 to 5,000,000.

EP-A-116 151 describes a process for regenerating water-based degreasing and cleaning solutions in which cationic surfactants or cationically modified polymers are added to the used, oil-laden cleaning solutions for demulsification. The emulsions present in the water are said to be broken in this way. The list of suitable cationic demulsifiers in the document in question contains inter alia protonated PEI. These cationic demulsifiers are also said to have the molecular weights mentioned in the above-cited WO specification. According to this teaching, therefore, the PEI is not present from the outset in the cleaning solution or hence during the actual cleaning process, but is added in a separate step for reprocessing the used cleaning solution.

WO 98/55578 describes low-foaming cleaning preparations for the industrial cleaning of hard surfaces which, instead of the anionic or non-ionic surfactants otherwise typically used, contain glycol ethers corresponding to the general formula R—O—(CH₂—CH(CH₃)—O)ₙ—H, where R is an alkyl group containing 1 to 4 carbon atoms or a phenyl group and n is a number of 1 to 5. The cleaning preparation in question additionally contains cationic surfactants, the ratio by weight of the glycol ethers to the cationic surfactants being between 8:1 and 100:1. The addition of PEI is not mentioned in the cited document.

### SUMMARY OF THE INVENTION

The problem addressed by the present invention was to provide an improved industrial cleaning preparation for hard surfaces, more particularly for metallic surfaces, which are soiled with oils and/or fats, for example for corrosion prevention or from preceding treatment steps, such as forming or machining for example. A water-based cleaning composition according to the invention is desirably sufficiently low-foaming in the in-use solution to be used in spraying processes and, at the same time, has demulsifying properties as described in the foregoing paragraphs. It is desirable that the cleaner is reliably low-foaming in use, even when soil types containing foam-generating components are adhered to the parts to be cleaned. This would be the case, for example, when the parts are soiled with residues of cooling lubricant emulsions which contain emulsifiers. In addition, the cleaning solution desirably retains its demulsifying properties despite the emulsifiers thus introduced. Since a variety of very different cooling lubricant emulsions can be introduced into the cleaning solution during the cleaning of parts, the absence of foam and a demulsifying effect towards a broad range of emulsifier-containing cooling lubricants is desirable. In addition, the components of the cleaning preparation desirably contain few, if any, potentially corrosive ions (more particularly chloride ions), which tend to have a negative effect on the metal substrates being cleaned.

### DETAILED DESCRIPTION OF EMBODIMENTS OF THE INVENTION

The present invention relates to a water-based cleaning concentrate and to the ready-to-use water-based cleaning solution which can be prepared therefrom. The invention also relates to processes for cleaning metallic surfaces soiled with oils and/or fats using a water-based cleaning composition, whether the concentrate or the ready-to-use cleaning solution, which meets some or all of the foregoing criteria.

In a first embodiment, the present invention relates to a water-based cleaning composition, either in concentrate or ready-to-use solution, containing:
a) water,
b) glycol ethers corresponding to the following general formula:
   R—O—(CH₂—CH(CH₃)—O)ₙ—H,
   where R is an alkyl group containing 1 to 4 carbon atoms or a phenyl group;
   and n is a number of 1 to 5
   and/or non-ionic surfactants; and
c) polyethylene imine and
d) optionally, cationic surfactants, corrosion inhibitors, builders, complexing agents, biocides and further auxiliaries or active components.

The water-based cleaning composition may contain either the glycol ethers mentioned above or non-ionic surfactants or a mixture thereof as the cleaning-active component b). If glycol ethers are to be used, they may be the same glycol ethers which are characterized in detail in the above-cited document WO 98/55578. Accordingly, glycol ethers in which n is a number in the range from 1 to 3 are preferred. Examples of such glycol ethers are tripropylene glycol monoethyl ether, dipropylene glycol n-butyl ether, tripropylene glycol n-butyl ether and propylene glycol phenyl ether. Tripropylene glycol monomethyl ether and tripropylene glycol butyl ether are preferred.

If non-ionic surfactants are used as component b), ethoxylates, propoxylates and/or ethoxylates/propoxylates of fatty alcohols are preferably used. Fatty alcohols are alkyl alcohols containing 6 to 22 and more particularly 8 to 18 carbon atoms in the alkyl group. Although the alkyl groups are preferably linear, they may also be branched. They may be saturated or mono- or poly-unsaturated. Fatty alcohol alkoxylates with only a single alkyl group or fatty alcohol alkoxylates with different alkyl groups, such as those derived from the fatty acids in naturally occurring vegetable or animal fats and oils, may be used. The degree of alkoxylation is generally in the range from about 1.5 to about 20. Propoxylates of fatty alcohols in which at least 50% of the alkyl groups represent a mono- or poly-unsaturated alkyl group containing 18 carbon atoms are preferred. Preferably at least 50% of the alkyl groups are oleyl groups. Propoxylates of fatty alcohols in which at least 90% of the alkyl groups are oleyl groups are particularly preferred. The degree of propoxylation can be between about 1.5 and about 6 and preferably between 1.5 and 3.

Component c), polyethylene imine, is commercially obtainable from various producers under various names. An overview of trade names and suppliers and a more detailed description of polyethylene imine can be found in the above-cited document U.S. Pat. No. 5,904,735, incorporated herein by reference, see in particular, column 16, line 49 to column 18, line 19. Polyethylene imines with very different molecular weights ranging from about 100 to about 5,000,000 are known. The molecular weights can be determined by gel permeation chromatography. As indicated in the above-cited reference, polyethylene imines can be linear or branched. In addition, they may be present in cationic form, i.e. in protonated form together with a counterion, or in neutral form. The neutral form is preferred for the purposes of the present invention because no additional anions are introduced as necessary counterions.

The presence of small quantities of cationic surfactants d) can be added generally to improve the demulsifying effect of PEI. Accordingly, the addition of small quantities of cationic surfactant (substantially smaller quantity than the quantity of PEI present) provides for a more reliable demulsifying effect towards a broad range of emulsifiers which can be introduced into the cleaning solution through cooling lubricants for example. Suitable cationic surfactants are, for example, quaternary organic ammonium compounds which contain at least one alkyl group with at least 10 carbon atoms. Suitable counterions are, for example, chloride ions or, preferably, carboxylate ions, such as propionate ions for example. The positive charge at the nitrogen atom can be produced not only by quaternization with 4 alkyl groups, but also by protonation of a tertiary amine. A suitable cationic surfactant is, for example, lauryl dimethyl benzyl ammonium chloride or N,N-didecyl-N-methyl poly(oxyethyl) ammonium propionate. In addition, it has been found that, where the cleaner is applied by spraying at pressures of >5 bar, far less air is introduced into the cleaning medium in the presence of the cationic surfactants. In practice, this means avoiding an unwanted pressure drop which can lead to a poorer cleaning performance or to damage to the pump of the washing unit.

Preferred concentration ranges for the individual active components in the cleaning concentrate (which is diluted with water for use) are:
non-ionic surfactants b): 0.25 to 5% by weight;
glycol ethers b): 0.5 to 20% by weight;
polyethylene imine c) 0.1 to 5% by weight, preferably 0.25 to 2% by weight;
cationic surfactants d): 0.01 to 1% by weight, preferably 0.05 to 0.5% by weight.

The molecular weight of the polyethylene imine (as determined by gel permeation chromatography) can vary over a wide range and, for example, may be between 800 and 750,000. However, it has been found that PEIs with a very low or very high molecular weight have a demulsifying effect towards a smaller number of introduced cooling lubricant types than PEIs having a molecular weight in the range from about 1200 to less than 50,000. In order to guarantee a broad range of application of the cleaning composition, the polyethylene imine c) preferably has an average molecular weight above 700, preferably above 1,200 and more particularly above 2,000 and below 50,000 and preferably below 35,000. More particularly, the molecular weight may be in the range from 5,000 to 25,000.

At least in the form in which it is mixed with the other active components of the cleaning concentrate, the PEI is preferably no more than 10% and more particularly no more than 1% protonated, quaternized or alkoxylated (the percentage being based on the total number of nitrogen atoms of the PEI polymer) and, preferably, is not protonated, quaternized or alkoxylated at all. In the case of alkoxylation, a reduced demulsifying effect would be expected. Protonation or quaternization, i.e. conversion into a cationic state, is not necessary for the demulsifying effect. In the absence of protonation or quaternization, there is no risk of the corresponding anions entering the cleaning concentrate and hence the cleaning solution. On the one hand, this avoids an unnecessary salt presence in the cleaning solution. On the other hand, it reduces the corrosiveness of the cleaning solution which can be produced by the counterions of the cationically modified PEI.

In a preferred embodiment, the cleaning concentrate additionally contains 5 to 60% by weight corrosion inhibitors. Alkanolamines, for example, are suitable corrosion inhibitors. Monoethanolamine, monoisopropanolamine, triethanolamine, triisopropanolamine and mixtures thereof are preferably used. By virtue of their outstanding corrosion-inhibiting effect, dialkanolamines may also be used. For toxicological reasons (risk of nitrosamine formation), however, the use of dialkanolamines is now avoided.

The corrosion inhibitors may also be selected from branched or unbranched, saturated or unsaturated aliphatic C₆₋₁₀ carboxylic acids and/or from aromatic C₇₋₁₀ carboxylic acids. At the pH values typically desired for so-called neutral cleaners, which are in the range from about 6.5 to about 9, the carboxylic acids are predominantly present as anions. Suitable counterions with which the acids can be neutralized are, for example, alkali metal ions such as, in particular, sodium or potassium ions, but preferably the cations of the above-mentioned alkanolamines. Examples of suitable carboxylic acids are caproic acid, caprylic acid, ethylhexanoic acid, heptanoic acid, isononanoic acid and benzoic acid or derivatives thereof, more particularly 3-nitrobenzoic acid or 4-hydroxybenzoic acid.

The cleaning concentrates may contain builders such as, for example, alkali metal orthophosphates, polyphosphates, silicates, borates, carbonates, polyacrylates and gluconates as further auxiliaries or active components. Some of these builders also have complexing properties and thus have a water-softening effect. Instead of or in addition to such builders, stronger complexing agents such as, for example, 1-hydroxyethane-1,1-diphosphonic acid or 2-phosphonobutane-1,2,4-tricarboxylic acid may be used. Ethylenediamine tetraacetates and nitrilotriacetates may also be used, although they do give rise to wastewater treatment problems. In order to protect the cleaning concentrates and the ready-to-use solutions prepared from them against microbial infestation, biocides may optionally be added.

The cleaner characterized in the foregoing is a concentrate from which the ready-to-use cleaning solution may be prepared by dilution. In principle, the cleaning solution could be prepared by dissolving the individual active components in water in the necessary concentration range. In the industrial sector concerned, however, it is normal for the manufacturer to supply concentrates which contain all the active components in the necessary quantity ratio and from which the user can prepare the ready-to-use cleaning solution by simple dilution with water. The concentrates are normally formulated so that they are used as a about 0.5 to about 5% by weight aqueous solution, i.e. they are diluted with water in a ratio of about 1:200 to about 1:20 for use. Accordingly, the present invention also relates to a ready-to-use water-based cleaner which is obtainable by diluting the cleaning concentrate described in detail herein with water in a ratio of about 1:200 to about 1:20 (i.e. 0.5 to 5 parts by weight concentrate are diluted with 99.5 to 95 parts by weight water). This water-based cleaning solution is used in particular for degreasing metal parts by spray application, for which purpose a temperature of about 15 to about 80° C. and more particularly in the range from about 40 to about 70° C. is generally used.

In another embodiment, the present invention relates to a process for cleaning metallic surfaces soiled with oils and/or fats, characterized in that the surfaces are contacted with a water-based cleaning solution comprising:
a) water,
b) glycol ethers corresponding to the following general formula:
   R—O—(CH₂—CH(CH₃)—O)ₙ—H,
   where R is an alkyl group containing 1 to 4 carbon atoms or a phenyl group;
   and n is a number of 1 to 5
   and/or non-ionic surfactants; and
c) polyethylene imine and
d) optionally, cationic surfactants, corrosion inhibitors, builders, complexing agents, biocides and further auxiliaries or active components.

The foregoing observations apply to the glycol ethers, the non-ionic surfactants and the polyethylene imine. The cleaning solution used in this process may additionally contain the cationic surfactants and/or corrosion inhibitors and/or other active components (builders, complexing agents) which are also described in the foregoing. The foregoing observations also apply accordingly to the cleaning solution used in the cleaning process in regard to preferred molecular weight ranges of the PEI and the preferred embodiment where the PEI is not protonated, quaternized or alkoxylated.

A cleaning solution in which the individual constituents are present in the following concentration ranges is preferably used in the cleaning process according to the invention:
non-ionic surfactants b): 0.002 to 0.25% by weight;
glycol ethers b): 0.002 to 4% by weight;
polyethylene imine c) 0.0005 to 0.25% by weight, preferably 0.001 to 0.1% by weight.

If cationic surfactants are present, their concentration is preferably in the range from 0.00005 to 0.05% by weight and more particularly in the range from 0.0002 to 0.025% by weight. Optionally used corrosion inhibitors are preferably present in concentrations of 0.025 to 2% by weight.

In the process according to the invention, the surfaces are contacted with the aqueous cleaning solution by immersion or preferably by spraying. The aqueous cleaning solution preferably has a temperature in the range from about 15 to about 80° C. and more particularly in the range from about 40 to about 70° C.

By virtue of the demulsifying properties of the cleaning solution, oil or fat floats on the cleaning solution, particularly if either the cleaning process is interrupted or a low-turbulence settling zone is provided in which oil or fat can be removed from the aqueous cleaning solution. The floating oil or fat is removed continuously or at intervals, so that the cleaning solution thus reprocessed can continue to be used for cleaning.

### EXAMPLES

For the individual test series, various quantities of PEI with various molecular weights were added to two different basic concentrates, which were then diluted with water to the in-use concentrations (all concentrations expressed in % by weight; EO=ethylene oxide; PO=propylene oxide).

Cleaner 1 (Concentrate)

12.0 monoethanolamine
24.0 triethanolamine
14.0 isononanoic acid
3.0 C₁₂/C₁₄ fatty alcohol×3 EO×6 PO
to 100 deionized water
   Cleaner 2 (Concentrate)
4.0 boric acid
0.4 glycerol
9.0 caprylic acid
14.5 monoethanolamine
0.2 hydroxyethyl ethylenediamine triacetic acid (Na salt)
3.5 fatty alcohol polyglycol ether (Dehypon® LT 4, Cognis)
1.7 octyl polyglycol ether (Dehydol® KE 2265, Cognis)
to 100 deionized water

The Following Polyethylene Imines Were Used:

| | |
|---|---|
| molecular weight: | 800 |
| molecular weight: | 1,300 |
| molecular weight: | 2,000 |
| molecular weight: | 5,000 |
| molecular weight: | 25,000 |
| molecular weight: | 750,000 |

The quantities of PEI added to the cleaners (concentrates) as indicated in the Examples are all based on a 50% by weight aqueous PEI solution. The actual PEI concentrations in the cleaners are therefore half of the amount listed in the Examples.

Part 1: Cleaning Tests

RR 1405 steel plates (size: 2.5×10 cm) were coated on one side with 200 μl of an oily soil (Soil A and B, see below). The oil coating was aged for 1 hour at 60° C. in a drying cabinet. The steel plates were then sprayed with the cleaning solution for 30 seconds at 65° C. and 1.5 bar pressure, and then rinsed with deionized water. After drying, the residue on the plate was oxidized in a stream of oxygen at 700° C. The oxidized carbon was determined by CO₂ detection, and the cleaning performance in % was determined therefrom by comparison with the blank value. See Table 1.

Parameters:

Soil A:

71.28% mineral oil, NYNAS T 400
9.00% di-tertiary dodecyl polysulfide
9.00% fatty acid dipentaerythritol ester
0.45% montan wax, partly saponified
0.27% polyethylene
10.00% polyisobutylene

This soil was diluted with petroleum ether at 80-110° C. so that a 15% mixture was formed. The coating was: 2625 mg/m² organic carbon (after aging).

Soil B:

20% caprylic acid/capric acid triglyceride (Myritol® 318, Cognis)
40% paraffin oil (Enerpar® 3036, BP)
40% petroleum ether 80/110° C.

This mixture was diluted with petroleum ether in a ratio of 1:1 at 80 to 110° C. The coating was: 5,900 mg/m² organic carbon (after aging)

Cleaning Solution 1:

Quantities of 1% by weight of the PEI types listed in Table 1 were added to Cleaner 1 (concentrate) and the cleaner was diluted with water to a concentration of 20 g/l to obtain Cleaning Solution 1.

Bath soiling: before the cleaning process, the Cleaning Solution 1 was soiled with 3 g/l oil (mixture of equal parts of Anticorit® RP 4107S from Fuchs, Enerpar® 3036 from BP and Myritol® 318 from Cognis) by mixing the cleaning solution with the oil mixture for 2 minutes using an Ultra Turrax (20,000 r.p.m.).

TABLE 1
Cleaning results

| PEI - type | | Residue | |
|---|---|---|---|
| molecular weight | Soil | [mg/m² org. C] | Cleaning performance |
| None (comparison) | B | 35 | 99.4% |
| None (comparison) | A | 74 | 97.2% |
| 800 | B | 41 | 99.3% |
| 800 | A | 87 | 96.7% |
| 1300 | B | 44 | 99.3% |
| 1300 | A | 80 | 97.0% |
| 2000 | B | 26 | 99.6% |
| 2000 | A | 41 | 98.4% |
| 5000 | B | 39 | 99.3% |
| 5000 | A | 53 | 98.0% |
| 25000 | B | 48 | 99.2% |
| 25000 | A | 46 | 98.3% |
| 750000 | B | 53 | 99.1% |
| 750000 | A | 117 | 95.5% |

As expected, the test showed that the addition of PEI does not affect the cleaning performance.

Part 2: Demulsification Tests With Oil-Containing Cooling Lubricant Emulsions

The demulsifying effect was tested by adding various commercially available oil-containing cooling lubricant emulsions from various producers to the cleaning solutions. The cooling lubricants and the results are set out in Table 2.

A corresponding quantity (see Table) of PEI was introduced into the cleaner (concentrate). 20 g of the PEI-containing concentrate was made up to 1 liter with tap water. 20 ml of a 5% cooling lubricant emulsion (prepared using tap water) were added in 5 seconds to 200 ml of this solution with stirring (ca. 500 r.p.m.) and the stability of the emulsion was evaluated after stirring for another 10 minutes. Demulsification was considered to occur if the emulsion droplets agglomerated and began to separate at the surface after the stirrer had been switched off, referred to in the Tables, below as “Breaking”.

TABLE 2
Demulsification results

| | | | Conc. | |
|---|---|---|---|---|
| | | | of PEI | |
| | | Breaker | in the | |
| | Cooling lubricant | (PEI with | cleaner (% | |
| Cleaner | emulsion | mol. weight) | by wt.) | Breaking |
| 1 | Alusol BA 370 | None (comparison) | 0 | No |
| 1 | Alusol BA 370 | 800 | 2 | Yes |
| 1 | Alusol BA 370 | 5000 | 1 | Yes |
| 1 | Alusol BA 370 | 5000 | 2 | Yes |
| 1 | Alusol BA 370 | 1300 | 2 | Yes |
| 1 | Alusol BA 370 | 2000 | 2 | Yes |
| 1 | Alusol BA 370 | 25000 | 1 | Yes |
| 1 | Alusol BA 370 | 25000 | 2 | Yes |
| 1 | Alusol BA 370 | 750000 | 1 | Yes |
| 1 | Alusol BA 370 | 750000 | 2 | Yes |

The above Example shows a readily breakable cooling lubricant, of which
the emulsion in the cleaning solution is broken by all PEI types at max.
2% in the cleaning concentrate.

| | | | | |
|---|---|---|---|---|
| 1 | Alusol DC 792 | None (comparison) | 0 | No |
| 1 | Alusol DC 792 | 5000 | 1 | No |
| 1 | Alusol DC 792 | 5000 | 2 | Yes |
| 1 | Alusol DC 792 | 1300 | 4 | No |
| 1 | Alusol DC 792 | 2000 | 2 | No |
| 1 | Alusol DC 792 | 2000 | 4 | Yes |
| 1 | Alusol DC 792 | 25000 | 1 | No |
| 1 | Alusol DC 792 | 750000 | 1 | No |
| 1 | Alusol DC 792 | 750000 | 2 | Yes |

In the above Example, PEI with a molecular weight of 1,300 does not
break, even at 4% in the concentrate. A molecular weight of 2,000 leads
to breaking at 4% while molecular weights of 5,000 and 750,000 lead to
breaking at only 2%.

| | | | | |
|---|---|---|---|---|
| 1 | Multan 21-60 | None (comparison) | 0 | No |
| 1 | Multan 21-60 | 5000 | 1 | No |
| 1 | Multan 21-60 | 5000 | 2 | Yes |
| 1 | Multan 21-60 | 1300 | 4 | No |
| 1 | Multan 21-60 | 2000 | 2 | No |
| 1 | Multan 21-60 | 2000 | 4 | Yes |
| 1 | Multan 21-60 | 25000 | 1 | No |
| 1 | Multan 21-60 | 750000 | 1 | No |
| 1 | Multan 21-60 | 750000 | 2 | Yes |

In the above Example, PEI with a molecular weight of 1,300 does not
break, even at 4% in the concentrate. A molecular weight of 2,000 leads
to breaking at 4% while molecular weights of 5,000 and 750,000 lead to
breaking at only 2%.

| | | | | |
|---|---|---|---|---|
| 1 | Multan 97-10 D | None (comparison) | 0 | No |
| 1 | Multan 97-10 D | 5000 | 1 | No |
| 1 | Multan 97-10 D | 5000 | 2 | Yes |
| 1 | Multan 97-10 D | 1300 | 4 | No |
| 1 | Multan 97-10 D | 2000 | 2 | No |
| 1 | Multan 97-10 D | 2000 | 4 | Yes |
| 1 | Multan 97-10 D | 25000 | 1 | Yes |
| 1 | Multan 97-10 D | 750000 | 1 | Yes |
| 1 | Multan 97-10 D | 750000 | 2 | Yes |

In the above instance, the emulsion is not broken by PEI with a
molecular weight of 1,300, even at 4% in the cleaning concentrate. With a
molecular weight of 2,000, breaking occurs at 4% and, with a molecular
weight of 5,000, at only 2%. With a molecular weight of 25,000, 1% is
sufficient whereas, with a molecular weight of 750,000, 2% is again
required.

| | | | | |
|---|---|---|---|---|
| 2 | Alusol BA 370 | None (comparison) | 0 | No |
| 2 | Alusol BA 370 | 800 | 2 | No |
| 2 | Alusol BA 370 | 5000 | 1 | Yes |
| 2 | Alusol BA 370 | 1300 | 2 | No |
| 2 | Alusol BA 370 | 2000 | 2 | No |
| 2 | Alusol BA 370 | 25000 | 1 | Yes |
| 2 | Alusol BA 370 | 750000 | 1 | Yes |

In the above Example, PEI types with molecular weights of 2,000 and
lower do not break at 2% in the concentrate whereas molecular weights of
5,000 and higher lead to breaking at only 1%.

| | | | | |
|---|---|---|---|---|
| 2 | Multan 21-60 | 5000 | 2 | No |
| 2 | Multan 21-60 | 5000 | 4 | Yes |
| 2 | Multan 21-60 | 2000 | 4 | No |
| 2 | Multan 21-60 | 25000 | 1 | No |
| 2 | Multan 21-60 | 25000 | 2 | Yes |
| 2 | Multan 21-60 | 750000 | 1 | No |
| 2 | Multan 21-60 | 750000 | 2 | No |
| 2 | Multan 21-60 | 750000 | 4 | Yes |

In the above Example, PEI with a molecular weight of 2,000 does not
break, even at 4% in the concentrate. With molecular weights of 5,000 on
the one hand and 750,000 on the other hand 4% is required for breaking
whereas, with a molecular weight of 25,000, 2% in the concentrate
is sufficient.

| | | | | |
|---|---|---|---|---|
| 2 | Multan 71-10 SK | None (comparison) | 0 | No |
| 2 | Multan 71-10 SK | 5000 | 1 | Yes |
| 2 | Multan 71-10 SK | 2000 | 2 | No |
| 2 | Multan 71-10 SK | 2000 | 4 | Yes |
| 2 | Multan 71-10 SK | 25000 | 1 | Yes |
| 2 | Multan 71-10 SK | 750000 | 1 | Yes |

In the above Example, PEI types with molecular weights of 5,000 and
higher break at only 1% in the concentrate. With a molecular weight of
2,000, a concentration of 4% is required.

| | | | | |
|---|---|---|---|---|
| 2 | Multan 77-70 | 5000 | 1 | No |
| 2 | Multan 77-70 | 5000 | 2 | Yes |
| 2 | Multan 77-70 | 2000 | 2 | No |
| 2 | Multan 77-70 | 2000 | 4 | Yes |
| 2 | Multan 77-70 | 25000 | 1 | No |
| 2 | Multan 77-70 | 25000 | 2 | Yes |
| 2 | Multan 77-70 | 750000 | 2 | No |
| 2 | Multan 77-70 | 750000 | 4 | Yes |

In the above Example, 4% in the concentrate is required for breaking
with a PEI molecular weight of 2,000; with molecular weights of 5,000
and 25,000, 2% is sufficient whereas, with 750,000, 4% is again required.

| | | | | |
|---|---|---|---|---|
| 2 | Multan 97-10 D | 5000 | 2 | Yes |
| 2 | Multan 97-10 D | 2000 | 4 | No |
| 2 | Multan 97-10 D | 25000 | 1 | Yes |
| 2 | Multan 97-10 D | 750000 | 2 | No |
| 2 | Multan 97-10 D | 750000 | 4 | Yes |

In the above Example, no breaking occurs with a PEI molecular weight
of 2,000, even at 4% in the concentrate. With a molecular weight of 5,000,
breaking occurs at 2% and, with a molecular weight of 25,000, at only 1%
whereas, with a molecular weight of 750,000, 4% is again required.

Part 3: Defoaming Effect

The PEIs were introduced into Cleaner 2 in the concentrations shown in Table 3 (% by weight in the cleaner=concentrate). A solution of 20 g/l in deionized water was prepared from the cleaning concentrate obtained. 1% and 5% of a 20% by weight cooling lubricant emulsion (prepared using deionized water) were added to the solution to simulate the introduction of cooling lubricant (“CL”). 100 ml of the solution thus obtained were heated to 50° C. in a 250 ml shaking cylinder. The solution was vigorously shaken by hand 10 times and the foam height was read immediately, after 30 seconds and after 60 seconds.

TABLE 3
Defoaming effect

| | | | Quantity of CL | Foam volume | | |
|---|---|---|---|---|---|---|
| PEI | % | | (% of the | (ml) after (time) | | |
| (mol. weight.) | PEI | Cooling lubricant | emulsion) | Initial | 30 secs. | 60 secs . . . |
| Comparison | 0 | Multan 71-10 SK | 5.0 | 150 | 120 | 110 |
| 800 | 2.0 | Multan 71-10 SK | 5.0 | 80 | 64 | 50 |
| 1300 | 2.0 | Multan 71-10 SK | 5.0 | 50 | 23 | 20 |
| 2000 | 2.0 | Multan 71-10 SK | 5.0 | 50 | 20 | 20 |
| 5000 | 2.0 | Multan 71-10 SK | 5.0 | 20 | 0 | 0 |
| 25000 | 2.0 | Multan 71-10 SK | 5.0 | 20 | 0 | 0 |
| 750000 | 2.0 | Multan 71-10 SK | 5.0 | 20 | 2 | 2 |
| 5000 | 1.0 | Multan 71-10 SK | 5.0 | 0 | 0 | 0 |
| 5000 | 0.5 | Multan 71-10 SK | 5.0 | 0 | 0 | 0 |
| 5000 | 0.2 | Multan 71-10 SK | 5.0 | 30 | 14 | 10 |
| Comparison | 0 | Multan 77-70 | 5.0 | 100 | 20 | 6 |
| 800 | 2.0 | Multan 77-70 | 5.0 | 50 | 0 | 0 |
| 1300 | 2.0 | Multan 77-70 | 5.0 | 40 | 0 | 0 |
| 2000 | 2.0 | Multan 77-70 | 5.0 | 20 | 0 | 0 |
| 5000 | 2.0 | Multan 77-70 | 5.0 | 30 | 0 | 0 |
| 25000 | 2.0 | Multan 77-70 | 5.0 | 20 | 0 | 0 |
| 750000 | 2.0 | Multan 77-70 | 5.0 | 30 | 0 | 0 |
| 5000 | 1.0 | Multan 77-70 | 5.0 | 0 | 0 | 0 |
| 5000 | 0.5 | Multan 77-70 | 5.0 | 90 | 10 | 4 |
| 5000 | 0.2 | Multan 77-70 | 5.0 | 80 | 20 | 10 |
| Comparison | 0 | Multan 21-60 | 5.0 | 150 | 16 | 6 |
| 800 | 2.0 | Multan 21-60 | 5.0 | 150 | 20 | 4 |
| 1300 | 2.0 | Multan 21-60 | 5.0 | 80 | 16 | 8 |
| 2000 | 2.0 | Multan 21-60 | 5.0 | 50 | 8 | 4 |
| 5000 | 2.0 | Multan 21-60 | 5.0 | 40 | 12 | 6 |
| 25000 | 2.0 | Multan 21-60 | 5.0 | 40 | 0 | 0 |
| 750000 | 2.0 | Multan 21-60 | 5.0 | 40 | 0 | 0 |
| Comparison | 0 | Multan 97-10D | 5.0 | 80 | 6 | 4 |
| 800 | 2.0 | Multan 97-10D | 5.0 | 60 | 6 | 4 |
| 1300 | 2.0 | Multan 97-10D | 5.0 | 30 | 4 | 4 |
| 2000 | 2.0 | Multan 97-10D | 5.0 | 10 | 6 | 6 |
| 5000 | 2.0 | Multan 97-10D | 5.0 | 10 | 4 | 4 |
| 25000 | 2.0 | Multan 97-10D | 5.0 | 10 | 6 | 6 |
| 750000 | 2.0 | Multan 97-10D | 5.0 | 10 | 4 | 4 |
| Comparison | 0 | Alusol.DC.792 | 5.0 | 130 | 100 | 90 |
| 800 | 2.0 | Alusol.DC.792 | 5.0 | 40 | 0 | 0 |
| 1300 | 2.0 | Alusol.DC.792 | 5.0 | 10 | 0 | 0 |
| 2000 | 2.0 | Alusol.DC.792 | 5.0 | 10 | 0 | 0 |
| 5000 | 2.0 | Alusol.DC.792 | 5.0 | 20 | 0 | 0 |
| 25000 | 2.0 | Alusol.DC.792 | 5.0 | 10 | 0 | 0 |
| 750000 | 2.0 | Alusol.DC.792 | 5.0 | 10 | 0 | 0 |
| 5000 | 1.0 | Alusol.DC.792 | 5.0 | 50 | 4 | 4 |
| 5000 | 0.5 | Alusol.DC.792 | 5.0 | 50 | 16 | 6 |
| 5000 | 0.2 | Alusol.DC.792 | 5.0 | 110 | 90 | 80 |
| Comparison | 0 | Multan 71-10 SK | 1.0 | 60 | 50 | 42 |
| 800 | 2.0 | Multan 71-10 SK | 1.0 | 40 | 3 | 3 |
| 1300 | 2.0 | Multan 71-10 SK | 1.0 | 5 | 0 | 0 |
| 2000 | 2.0 | Multan 71-10 SK | 1.0 | 23 | 0 | 0 |
| 5000 | 2.0 | Multan 71-10 SK | 1.0 | 5 | 0 | 0 |
| 25000 | 2.0 | Multan 71-10 SK | 1.0 | 20 | 0 | 0 |
| 750000 | 2.0 | Multan 71-10 SK | 1.0 | 0 | 0 | 0 |
| 5000 | 1.0 | Multan 71-10 SK | 1.0 | 0 | 0 | 0 |
| 5000 | 0.5 | Multan 71-10 SK | 1.0 | 0 | 0 | 0 |
| 5000 | 0.2 | Multan 71-10 SK | 1.0 | 0 | 0 | 0 |
| Comparison | 0 | Multan 77-70 | 1.0 | 50 | 0 | 0 |
| 800 | 2.0 | Multan 77-70 | 1.0 | 0 | 0 | 0 |
| 1300 | 2.0 | Multan 77-70 | 1.0 | 0 | 0 | 0 |
| 2000 | 2.0 | Multan 77-70 | 1.0 | 0 | 0 | 0 |
| 5000 | 2.0 | Multan 77-70 | 1.0 | 0 | 0 | 0 |
| 25000 | 2.0 | Multan 77-70 | 1.0 | 0 | 0 | 0 |
| 750000 | 2.0 | Multan 77-70 | 1.0 | 0 | 0 | 0 |
| 5000 | 1.0 | Multan 77-70 | 1.0 | 0 | 0 | 0 |
| 5000 | 0.5 | Multan 77-70 | 1.0 | 8 | 0 | 0 |
| 5000 | 0.2 | Multan 77-70 | 1.0 | 10 | 0 | 0 |
| Comparison | 0 | Multan 21-60 | 1.0 | 100 | 10 | 6 |
| 800 | 2.0 | Multan 21-60 | 1.0 | 20 | 0 | 0 |
| 1300 | 2.0 | Multan 21-60 | 1.0 | 0 | 0 | 0 |
| 2000 | 2.0 | Multan 21-60 | 1.0 | 0 | 0 | 0 |
| 5000 | 2.0 | Multan 21-60 | 1.0 | 0 | 0 | 0 |
| 25000 | 2.0 | Multan 21-60 | 1.0 | 0 | 0 | 0 |
| 750000 | 2.0 | Multan 21-60 | 1.0 | 0 | 0 | 0 |
| Comparison | 0 | Multan 97-10D | 1.0 | 60 | 4 | 4 |
| 800 | 2.0 | Multan 97-10D | 1.0 | 40 | 0 | 0 |
| 1300 | 2.0 | Multan 97-10D | 1.0 | 2 | 0 | 0 |
| 2000 | 2.0 | Multan 97-10D | 1.0 | 2 | 0 | 0 |
| 5000 | 2.0 | Multan 97-10D | 1.0 | 2 | 0 | 0 |
| 25000 | 2.0 | Multan 97-10D | 1.0 | 4 | 2 | 2 |
| 750000 | 2.0 | Multan 97-10D | 1.0 | 8 | 4 | 4 |
| Comparison | 0 | Alusol.DC.792 | 1.0 | 90 | 60 | 30 |
| 800 | 2.0 | Alusol.DC.792 | 1.0 | 20 | 0 | 0 |
| 1300 | 2.0 | Alusol.DC.792 | 1.0 | 0 | 0 | 0 |
| 2000 | 2.0 | Alusol.DC.792 | 1.0 | 0 | 0 | 0 |
| 5000 | 2.0 | Alusol.DC.792 | 1.0 | 0 | 0 | 0 |
| 25000 | 2.0 | Alusol.DC.792 | 1.0 | 10 | 0 | 0 |
| 750000 | 2.0 | Alusol.DC.792 | 1.0 | 10 | 0 | 0 |
| 5000 | 1.0 | Alusol.DC.792 | 1.0 | 0 | 0 | 0 |
| 5000 | 0.5 | Alusol.DC.792 | 1.0 | 0 | 0 | 0 |
| 5000 | 0.2 | Alusol.DC.792 | 1.0 | 30 | 6 | 6 |

The results show that, under conditions selected for the tests, all PEI types have a foam-suppressing effect. This effect was generally more pronounced with a PEI molecular weight of 2,000 and higher, than with a PEI molecular weight of 1,300 and 800.

Part 4: Addition of Cationic Surfactants

Cleaner 3 (Concentrate)

Quantities in % by weight

4.0 boric acid
9.0 caprylic acid
14.5 monoethanolamine
0.2 hydroxyethyl ethylenediamine triacetic acid (Na salt)
2.0 polyethylene imine, 50% (molecular weight 25,000)
to 100 deionized water

Both a non-ionic surfactant and a cationic surfactant as indicated in the Table were added to Cleaner 3. A foam test is then carried out in a spray washing unit. To this end, a 2% by weight cleaning solution in tap water (About 16° dH) was prepared. 4 liters of this solution were sprayed for 10 minutes. at 50° C. using a single-nozzle sprayer (initial spraying pressure 10 bar). The pressure and the foam height (=height of foam above the liquid surface in the starting position) were measured during spraying.

Cationic Surfactants:

C1=lauryl dimethyl benzyl ammonium chloride
C2=N,N-didecyl-N-methyl poly(oxyethyl) ammonium propionate

Results:

TABLE 4
Defoaming effect

| | | Non-ionic | Cationic | Cationic | | |
|---|---|---|---|---|---|---|
| | | surfactant | surfactant | surfactant | Pressure | Foam |
| No. | Non-ionic surfactant | (%) | used | (%) | (bar) | (mm) |
| 1 | C₁₂/C₁₄-Fatty alcohol × 3 EO × 6 PO | 3.0 | — | — | 5 | 25 |
| 2 | C₁₂/C₁₄-Fatty alcohol × 3 EO × 6 PO | 3.0 | C1 | 0.1 | 10 | 0 |
| 3 | C₁₂/C₁₄-Fatty alcohol × 3 EO × 6 PO | 3.0 | C2 | 0.14 | 10 | 10 |
| 4 | Oleyl-Cetyl alcohol × 2 PO | 1.0 | — | — | 8 | 15 |
| 5 | Oleyl-Cetyl alcohol × 2 PO | 0.8 | C1 | 0.1 | 10 | 10 |
| 6 | Oleyl-Cetyl alcohol × 2 PO | 0.8 | C2 | 0.14 | 10 | 10 |

The effect of adding small quantities of cationic surfactants is that there is no reduction in the spraying pressure during spraying and foaming is also clearly reduced. This all the more remarkable insofar as the cationic surfactants foam vigorously on their own.

This invention relates to a low-foaming cleaning preparation (in the form of a concentrate and ready-to-use solution) for hard surfaces, and processes for using this product to clean metallic surfaces. It can be used in many variations of the processes that are employed in industrial metal forming and shaping. While the invention has been described in terms of specific embodiments thereof, it will be appreciated that other forms could readily be adapted by one skilled in the art. Accordingly, the scope of the invention is to be considered limited only by the following claims.

1. A process for cleaning metallic surfaces soiled with oils and/or fats, that comprises:
contacting said metallic surfaces with a water-based cleaning solution comprising:
a) water;
b) one or more non-ionic surfactants and/or glycol ethers, said glycol ethers corresponding to the following general formula:
R—O—(CH₂—CH(CH₃)—O)ₙ—H,
where R is an alkyl group having 1 to 4 carbon atoms or a phenyl group; and
n is a number from 1 to 5; and
c) polyethylene imine.

2. The process as claimed in claim 1, further comprising the additional step of:
removing oils and/or fats floating on the water-based cleaning solution after said contacting with the metallic surfaces thereby yielding a reprocessed cleaning solution.

3. The process as claimed in claim 2, wherein the water-based cleaning solution of the contacting step comprises reprocessed cleaning solution.

4. The process as claimed in claim 3, further comprising the additional step of:
providing a settling zone for floating the oils and/or fats on the water-based cleaning solution.

5. The process as claimed in claim 1, wherein the water-based cleaning solution additionally comprises cationic surfactants, corrosion inhibitors, complexing agents, biocides, builders and/or auxiliaries.

6. The process as claimed in claim 1, wherein the polyethylene imine c) is neither protonated nor quaternized.

7. The process as claimed in claim 6, wherein the polyethylene imine c) is unalkoxylated.

8. The process as claimed in claim 6, wherein the polyethylene imine c) has an average molecular weight above 700 and below 50,000.

9. The process as claimed in claim 1, wherein the water-based cleaning solution comprises polyethylene imine c) in a concentration of 0.0005 to 0.25% by weight.

10. The process as claimed in claim 9, wherein the water-based cleaning solution comprises non-ionic surfactants b) in a concentration of 0.002 to 0.25% by weight.

11. The process as claimed in claim 10, wherein the water-based cleaning solution comprises glycol ethers b) in a concentration of 0.002 to 4% by weight.

12. The process as claimed in claim 11, wherein the water-based cleaning solution further comprises cationic surfactants d) in a concentration of 0.00005 to 0.05% by weight.

13. A process for cleaning metallic surfaces soiled with oils and/or fats, that comprises:
contacting said metallic surfaces with a water-based cleaning composition made by combining at least:
a) water
b) non-ionic surfactants and/or glycol ethers, said glycol ethers corresponding to the following general formula:
R—O—(CH₂—CH(CH₃)—O)ₙ—H,
where R is an alkyl group having 1 to 4 carbon atoms or a phenyl group; and
n is a number from 1 to 5; and
c) polyethylene imine, no more than 10% of said polyethylene imine being protonated, quaternized or alkoxylated.

14. The process as claimed in claim 13, wherein the water-based cleaning composition comprises:
a) water;
b) 0.25 to 5% by weight non-ionic surfactants and/or 0.5 to 20% by weight glycol ethers;
c) 0.1 to 5% by weight polyethylene imine;
d) 0.01 to 1% by weight cationic surfactants; and
optionally, corrosion inhibitors, builders, complexing agents, biocides and auxiliaries.

15. The process as claimed in claim 14 wherein said cationic surfactants comprise quaternary organic ammonium compounds comprising at least one alkyl group with at least 10 carbon atoms.

16. The process as claimed in claim 14, wherein water-based cleaning composition comprises 5 to 60% by weight corrosion inhibitors selected from branched or unbranched, saturated or unsaturated aliphatic C₆₋₁₀ carboxylic acids, aromatic C₇₋₁₀ carboxylic acids and/or alkanolamines.

17. The process as claimed in claim 14 wherein said non-ionic surfactants comprise one or more alkoxylated linear and/or branched alkyl alcohols containing 6 to 22 carbon atoms in the alkyl group and having a degree of alkoxylation in the range from about 1.5 to about 20.

18. The process as claimed in claim 17 wherein said alkoxylated linear and/or branched alkyl alcohols comprise propoxylated alkyl alcohols, in which at least 50% of the alkyl groups represent a mono- or poly-unsaturated alkyl group containing about 18 carbon atoms, said propoxylated alkyl alcohols having a degree of propoxylation between about 1.5 and about 6.

19. A process for cleaning metallic surfaces soiled with oils and/or fats, that comprises:
contacting said metallic surfaces with a water-based cleaning composition comprising:
a) water
b) at least one of:
i. 0.002 to 4% by weight of a glycol ether, said glycol ether corresponding to the following general formula:
R—O—(CH₂—CH(CH₃)—O)ₙ—H,
where R is an alkyl group having 1 to 4 carbon atoms or a phenyl group; and n is a number from 1 to 5; and/or
ii. 0.002 to 0.25% by weight of a non-ionic surfactant selected from C₈₋₁₈ fatty alcohol alkoxylates having a degree of alkoxylation in the range of about 1.5 to about 20;
c) 0.0005 to 0.25% by weight polyethylene imine, no more than 10% of said polyethylene imine being protonated, quaternized or alkoxylated;
d) 0.00005 to 0.05% by weight cationic surfactants; and
e) 0.025 to 2.0% by weight corrosion inhibitors; and
demulsifying the water-based cleaning composition such that the oils and/or fats cleaned from said metallic surfaces float on said cleaning composition; and
removing the floating oils and/or fats.
